(19) United States
(12) Patent Application Publication
(10) Pub. No.: US 2026/0321463 A1
(43) Pub. Date: Oct. 15, 2026

(54) CABLE CORE AND COMMUNICATION CABLE

(71) Applicant: GUANGDONG IPT INDUSTRIAL CO., LTD., Dongguan (CN)

(72) Inventor: Zihe WANG, Dongguan (CN)

(21) Appl. No.: 18/996,989

(22) PCT Filed: Jul. 3, 2024
(86) PCT No.: PCT/CN2024/103272

§ 371 Date: Jan. 18, 2025

(30) Foreign Application Priority Data
Nov. 14, 2023 (CN) 202311507571.X
Nov. 14, 2023 (CN) 202311507573.9
Nov. 14, 2023 (CN) 202311507577.7

(51) Int. Cl. H01B 11/06

(52) U.S. Cl. CPC H01B 11/06

(57) ABSTRACT

The present disclosure relates to a cable core and a communication cable. The cable core includes a conductor and an insulation dielectric layer wrapping the conductor; a plurality of holes parallel to an axis of the conductor are uniformly provided around the conductor inside the insulation dielectric layer; supporting structures are formed between adjacent holes; in any cross section of the cable core, shapes of cross sections of the various holes are the same and are all axisymmetric figures; and an axis of symmetry of the cross section of each hole is intersected with a circle center of the cross section of the conductor. Beneficial effects of the cable core are as follows: The cable core has a stable structure and is hardly broken under force, so that the compressive strength is improved; the stability of the dielectric constant of an insulation medium is improved; the signal transmission efficiency is improved; and the machining precision of the cable core is improved.

### TECHNICAL FIELD

The present disclosure belongs to the technical field of communication cables, and in particular, to a cable core and a communication cable.

### BACKGROUND

Communication cable is a general term for various wires configured to transmit electrical or optical signals. With an increasing demand for the transmission speed between an electronic device and a component, the improvement of the data transmission speed is of great significance to the communication industry. Therefore, communication cables and optical fibers have become main transmission methods.

The traditional communication cable is mainly composed of a cable core, an insulation layer, a shielding layer, and a protective layer. The structural design of the cable core in the shielding layer has a decisive impact on the transmission speed. The cable core includes a conductor and a dielectric layer wrapped outside the conductor. To achieve a high speed for the cable, a comprehensive dielectric constant ε of an insulation dielectric layer needs to always remain uniform and stable. However, in some application scenarios, especially when some communication cables with small outer diameters are required (e.g. to be applied to aviation equipment), due to the limitation on a mounting space, the cable core would be stretched, bent or even pressed by force. When the existing communication cable is stretched, bent, or even pressed by the force, the cable core is easily broken, and the comprehensive dielectric constant ε of the insulation dielectric layer is not stable enough.

Therefore, it is necessary to provide a cable core and a communication cable with high flexibility and a stable dielectric constant of an insulation dielectric layer.

### SUMMARY

### (i) Technical Problem to Be Solved

In view of the above defects and shortcomings in the prior art, the present disclosure provides a cable core and a communication cable.

### (II) Technical Solution

To achieve the above objectives, the present disclosure provides the following technical solutions:

In a first aspect, the embodiments of the present disclosure provide a cable core, including a conductor and an insulation dielectric layer wrapping the conductor.

A plurality of holes parallel to an axis of the conductor are uniformly provided around the conductor inside the insulation dielectric layer. Supporting structures are formed between adjacent holes.

In any cross section of the cable core, shapes of cross sections of the various holes are the same and are all axisymmetric figures. An axis of symmetry of the cross section of each hole is intersected with a circle center of the cross section of the conductor.

In a second aspect, the embodiments of the present disclosure provide a communication cable, including at least one cable core as described in the first aspect.

### (III) Beneficial Effects

Beneficial effects of the present disclosure are as follows:
1. The supporting structures of the cable core can keep the structure of the insulation dielectric layer stable when the cable core is stressed, so that the dielectric constant of the insulation dielectric layer remains stable. Furthermore, the combination of the holes and the supporting structures increases the flexibility of the insulation dielectric layer, and the insulation dielectric layer is hardly broken when stretched, bent, or pressed. Moreover, the weight of the cable core is reduced, so that the value of the dielectric constant is reduced, and the signal transmission rate of the communication cable is increased.
2. The symmetric structure of the cable core ensures the accuracy of a mold, which is conductive to improving the machining precision and is more suitable for high-speed high-frequency communication cables with finer structures.

### BRIEF DESCRIPTION OF THE DRAWINGS

The present disclosure will be described in virtue of the following accompanying drawings:

FIG. 1 is a schematic diagram of a cross-sectional structure of a cable core in some feasible solutions according to Embodiment 1 of the present disclosure;

FIG. 2 is a schematic diagram of a cross-sectional structure of a cable core in some other feasible solutions according to Embodiment 1 of the present disclosure;

FIG. 3 is a schematic diagram of a cross-sectional structure of a cable core in still some other feasible solutions according to Embodiment 1 of the present disclosure;

FIG. 4 is a schematic diagram of a cross-sectional structure of a cable core in yet still some other feasible solutions according to Embodiment 1;

FIG. 5 is a schematic structural diagram of a differential signal wire group that only includes two cable cores in some feasible solutions according to Embodiment 2 of the present disclosure;

FIG. 6 is a schematic structural diagram of a differential signal wire group that is provided with one ground wire in some feasible solutions according to Embodiment 2 of the present disclosure;

FIG. 7 is a schematic structural diagram of a differential signal wire group that is provided with two ground wire in some feasible solutions according to Embodiment 2 of the present disclosure;

FIG. 8 is a schematic structural diagram of a differential signal wire group that is provided with a positioning notch in some feasible solutions according to Embodiment 2 of the present disclosure;

FIG. 9 is a schematic structural diagram of a differential signal wire group that is provided with a positioning notch in some other feasible solutions according to Embodiment 2;

FIG. 10 is a schematic structural diagram of a differential signal wire group that is provided with a positioning notch in some other feasible solutions according to Embodiment 2;

FIG. 11 is a schematic diagram of a cross-sectional structure of a communication cable that is provided with a single row of connected cable in some feasible solutions according to Embodiment 3 of the present disclosure;

FIG. 12 is a schematic diagram of a cross-sectional structure of a cable core that is provided with two rows of connected cables in some feasible solutions according to Embodiment 3 of the present disclosure;

FIG. 13 is a schematic diagram of a cross-sectional structure of a communication cable that is provided with a single row of connected cable in some feasible solutions according to Embodiment 3 of the present disclosure;

FIG. 14 is a schematic diagram of a cross-sectional structure of a cable core that is provided with two rows of connected cables in some other feasible solutions according to Embodiment 3 of the present disclosure;

FIG. 15 is a schematic diagram of a cross-sectional structure of a high-speed differential cable in some feasible solutions according to Embodiment 5 of the present disclosure; and

FIG. 16 is a schematic diagram of a cross-sectional structure of a high-speed differential cable in some other feasible solutions according to Embodiment 5 of the present disclosure.

### DESCRIPTION OF REFERENCE NUMERALS

11: conductor; 12: insulation dielectric layer; 121: hole; 122: supporting structure; 13: outer cable core coating layer; O: center of circle; L: axis of symmetry; S1: center point of inverted triangle; S2: center point of inverted triangle;
20: differential signal wire group; 21: ground wire; 22: wire group shielding layer; 221: first connecting rib; 23: positioning notch; 24: middle wire group coating layer; 25: outer wire group coating layer; 26: first shielding layer; 27: second shielding layer; 28: outer cable coating layer; 281: second connecting rib; 29: braided layer; and 30: anti-brake notch.

### DETAILED DESCRIPTION OF THE EMBODIMENTS

To better explain the present disclosure, for ease of understanding, the present disclosure will be described in detail below in combination with the accompanying drawings through specific implementations. It can be understood that the specific embodiments described below are only used to explain the relevant invention, rather than limiting this invention. It should be further noted that the embodiments in the present disclosure and features in the embodiments may be mutually combined without conflicts. For ease of description, the accompanying drawings only show parts related to this invention.

### Embodiment I

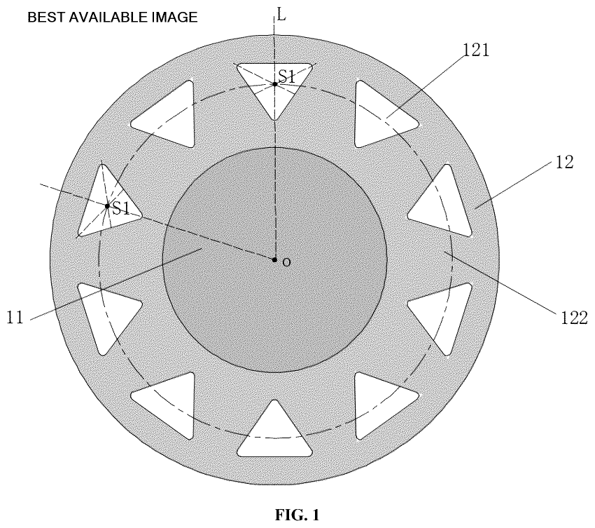

Referring to FIG. 1 to FIG. 4, this embodiment provides a cable core applicable to a communication cable, including a conductor 11 and an insulation dielectric layer 12 wrapping the conductor 11. A plurality of holes 121 parallel to an axis of the conductor 11 are uniformly provided around the conductor 11 inside the insulation dielectric layer 12; and supporting structures 122 are formed between adjacent holes 121. These supporting structures 122 can keep the structure of the insulation dielectric layer 12 stable when force is applied to the cable core, so that the dielectric constant of the insulation dielectric layer 12 is kept stable.

In any cross section of the cable core, shapes of cross sections of the various holes 121 are the same and are all axisymmetric figures; and an axis L of symmetry of the cross section of each hole 121 is intersected with a circle center O of the cross section of the conductor 11. Therefore, the axis L of symmetry of each hole 121 is also an axis of symmetry of the cable core, so that the various holes 121 are uniformly distributed around the entire conductor 11 to ensure that the dielectric constants in all directions are consistent.

The combination of the holes 121 and the supporting structures 122 increases the flexibility of the insulation dielectric layer 12, and the insulation dielectric layer is hardly broken when stretched, bent, or pressed. Moreover, the weight of the cable core is reduced, and the dielectric constant is reduced. The symmetric structure of the cable core ensures the accuracy of a mold, which is conductive to improving the machining precision and is more suitable for high-speed high-frequency communication cables with finer structures.

The cross section of each hole 121 may use axisymmetric shapes such as a circle, an ellipse, and an equilateral polygon, and the axis of symmetry L is intersected with the circle center O of the conductor 11, so that the various holes 121 are circumferentially symmetrically distributed around the entire cable core to ensure that the dielectric constants in all the directions are consistent. Meanwhile, by use of this structure, the dielectric constant can decrease from 2.3 to 1.1. After the dielectric constant decreases, the transmission rate is higher, which can increase from 32 G to 64 G.

A material of the conductor 11 includes galvanized copper or tin-plated copper. The insulation dielectric layer 12 can be made using a foaming process, and its material can be polypropylene (PP), fluorinated ethylene propylene (FEP), polyethylene (PE), soluble polytetrafluoroethylene (PFA), or polytetrafluoroethylene (PTFE). A material of an outer coating layer includes polyvinyl chloride (PVC), thermoplastic rubber (TPE), polyurethane (PU), ethylene tetrafluoroethylene copolymer (ETFE), PFA, PP, PE, cross-linked polyethylene (XLPE), or chlorinated polyethylene (CPE).

In some feasible solutions, referring to FIG. 1, the cross section of each hole 121 is in a shape of an isosceles triangle; each isosceles triangle is an inverted triangle; and a cross section of each supporting structure 122 is columnar.

In this embodiment, the inverted triangle means an isosceles triangle with a vertex angle pointing towards the axis of the conductor (11); and a forward triangle means an isosceles triangle with a vertex angle pointing towards a direction opposite to a direction pointed by the inverted triangle.

Continuing to refer to FIG. 1, the conductor 11 has a circular cross section. A vertical line from a vertex of each inverted triangle to a bottom edge (i.e., the axis L of symmetry) is intersected with the circle center O of the circular cross section of the conductor 11. The center points S1 are uniformly distributed on a circumference of a concentric circle of the circular cross section of the conductor 11, namely, distances from the center points S1 of the various inverted triangles to the circle center O are equal.

The cross section of each supporting structure 122 is columnar, and a width of one end of the supporting structure away from the conductor 11 is less than a width of the other end.

Each hole 121 may be an equilateral triangle, or an isosceles triangle only having two equal edges, where a value of a vertex angle of the triangle is greater than a value of a base angle. For example, the vertex angle is set to 70°, and the base angle is set to 55°. The value of the vertex angle is greater than the value of the base angle, which is conducive to forming a columnar structure with a small outer end and a large inner end to achieve a better supporting effect, thereby avoiding a narrow cross section of each hole 121. It further improves the machining accuracy of the cable core.

The cross section of each hole 121 adopts the structurally stable isosceles triangle, which improves the structural stability of the cable core. Therefore, when the cable core is applied with external force, such as compression and bending, the cable core has higher compressive strength and is more likely to rebound after the external force disappears. By the arrangement of the inverted triangle-shaped holes having the vertex angles pointing to the circle center of the conductor, when the cable core is bent, the force on the position where the vertex angle is located is more centralized, which further improves the attachment force of the insulation dielectric layer to the conductor. The protective effect on the cable core under the external force is better.

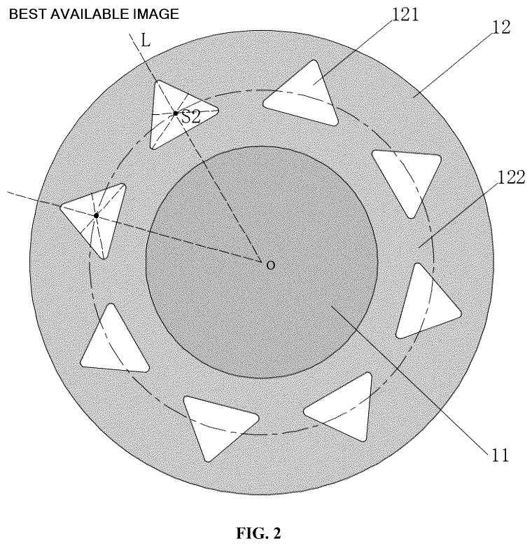

In some feasible solutions, referring to FIG. 2, each isosceles triangle is a forward triangle, and distances from center points S2 of the various forward triangles to the circle center O are equal. A cross section of each supporting structure 122 is columnar.

A vertical line from a vertex of each forward triangle to a bottom edge (i.e., the axis L of symmetry) is intersected with the circle center O of the circular cross section of the conductor 11. The center points S2 are uniformly distributed on a circumference of a concentric circle of the circular cross section of the conductor 11, namely, distances from the center points S2 of the various forward triangles to the circle center O are equal.

When the cross sections of the various holes 11 are all forward triangles or inverted triangles, the number of the holes 121 arranged around the conductor 11 may be odd, such as 9, 11, or 13, or even, such as 8, 10, or 12. When the number of the holes 121 is even, the holes 121 can be uniformly and symmetrically distributed around the conductor 11.

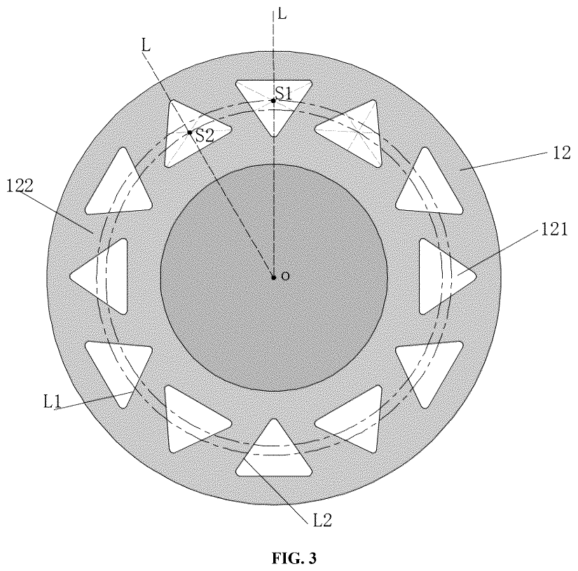

In some feasible solutions, referring to FIG. 3, the isosceles triangles include forward triangles and inverted triangles, and the forward triangles and the inverted triangles are spaced apart from each other.

Distances from the center points S1 of the various inverted triangles to the circle center O are equal, and distances from the center points S2 of the various forward triangles to the circle center O are equal too. The distances from the center points S1 of the inverted triangles to the circle center O are greater than the distances from the center points S2 to the circle center, so that the positions of the vertexes of the inverted triangles are flush or almost flush with the positions of the edges of the forward triangles, thereby avoiding interference between the forward triangles and the inverted triangles adjacent to the forward triangles, and avoiding breakage caused when force is applied to the cable core as positions of the supporting structures 122 close to the conductor 11 are too thin.

The number of the forward triangles is equal to the number of the inverted triangles and can be even. For example, there are six forward triangles and six inverted triangles, namely, there are 12 holes in total. Two supporting structures 122 on two sides of each forward triangle form a group, uniformly and symmetrically distributed around the conductor 11. Side edges L1 and L2 of the two supporting structures 122 are parallel to each other. This can make the entire cable core have a symmetrical circumferential structure, ensuring that the dielectric constants in all the directions are consistent. Meanwhile, it is conductive to improving the flexibility of the cable core.

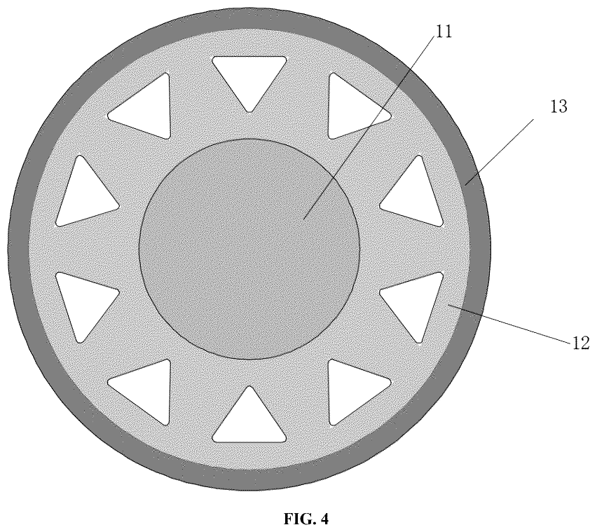

In some feasible solutions, referring to FIG. 4, the cable core further includes an outer cable core coating layer 13 wrapping the insulation dielectric layer 12.

In some feasible solutions, when the cable core is applied in a communication cable of a small structure, a diameter of the conductor 11 is 0.16 mm to 0.2 mm; a diameter of the insulation dielectric layer 12 is 0.32 mm to 0.4 mm; and a side length of the isosceles triangle of the cross section of each hole is 0.02 mm.

In practical applications, the diameter and impedance of the cable core 10 can be selected according to an actual situation.

### Embodiment II

Based on the above Embodiment I, Embodiment II provides a differential wire group.

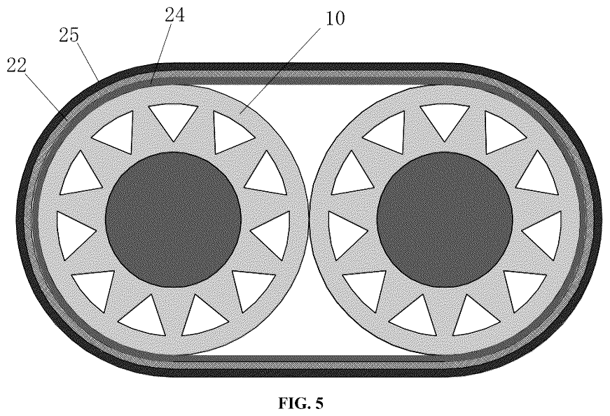

In some feasible solutions, referring to FIG. 5 to FIG. 11, a differential signal wire group 20 includes two cable cores 10 arranged side by side; and adjacent supporting structures 122 of the two cable cores 10 are aligned with each other.

The structure of the cable core 10 can be found in Embodiment I, and will not be elaborated here.

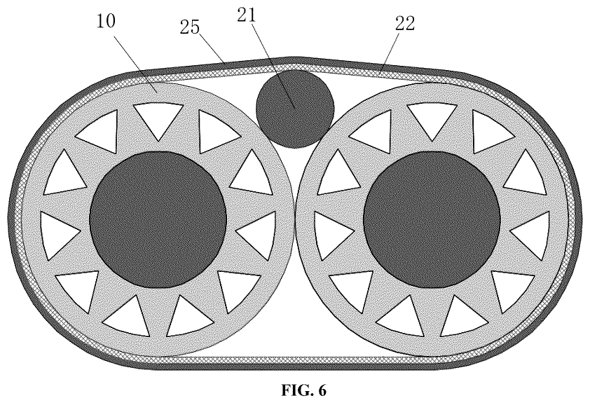

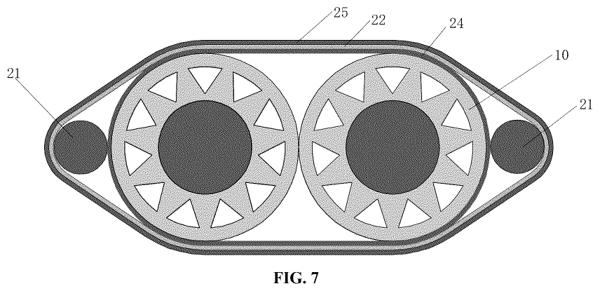

In actual applications, the differential signal wire group may only include two cable cores 10, as shown in FIG. 5. The two cable cores (10) are wrapped together by a middle wire group coating layer 24; and a wire group shielding layer 22 and an outer wire group coating layer 25 wrap the middle wire group coating layer 24 in sequence. Or, the differential signal wire group may further include one ground wire 21, as shown in FIG. 6. The ground wire 21 is arranged at adjacent positions of the two cable cores 10. The wire group shielding layer 22 wraps the two cable cores 10 and the ground wire 21 together, and the outer wire group coating layer 25 wraps the wire group shielding layer 22. Or, the differential signal wire group may further include two ground wires 21, as shown in FIG. 7. The two cable cores 10 are wrapped together by a middle wire group coating layer 24; the two ground wires 21 are located at two ends of an outer side of the middle wire group coating layer 24; a wire group shielding layer 22 wraps the ground wires 21 and the cable cores 10 wrapped by the middle wire group coating layer 24 together; and an outer wire group coating layer 25 wraps the wire group shielding layer 22.

The middle wire group coating layer 24 can be machined by extrusion or bagging. The wire group shielding layer may be made of an aluminum foil, a copper foil, graphene, and the like. Its width and thickness can be customized. The wire group shielding layer can be machined by dragging or winding. The outer wire group coating layer may be machined by extruding hot-melt mylar or plastic.

The cable cores 10 and the ground wires 21 that form the differential signal wire group can be alternatively directly wrapped by an outer cable coating layer 28.

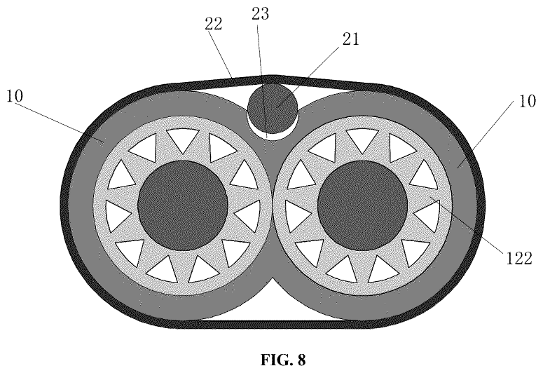

In some feasible solutions, referring to FIG. 8 to FIG. 11, the cable cores 10 may be further provided with positioning notches 23, and the ground wires 21 cooperate with the positioning notches 23.

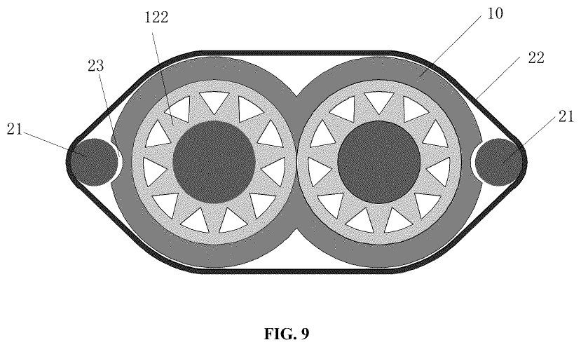

In practical applications, there may be one ground wire 21, as shown in FIG. 8. At this time, the positioning notch 23 is provided at adjacent positions of the two cable cores 10 that are arranged side by side. Or, there may be two ground wires 21 too, as shown in FIG. 9. One positioning notch 23 is provided on each of two sides of the two cable cores 10 that are arranged side by side, and the two ground wires 21 are respectively located on the two sides of the two cable cores 10 that are arranged side by side and cooperate with the corresponding positioning notches 23.

It is not necessary to design an outer cable core coating layer 13 for the cable cores 10. If the cable cores 10 are provided with the outer cable core coating layers 13, the positioning notches 23 can be arranged on the outer cable core coating layers 13. If the cable cores 10 are not provided with the outer cable core coating layers 13, the positioning notches 23 can be arranged on the insulation dielectric layer 12. The outer cable core coating layers 13 can be used to wrap the two cable cores 10 together. At this time, the functions of the outer cable core coating layers 13 are the same as the function of the middle wire group coating layer 24, namely, wrapping the two cable cores 10 together. In practical applications, the outer cable core coating layers 13 is separately arranged on each cable core 10.

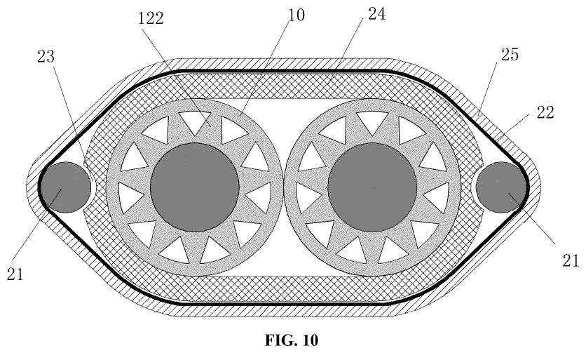

In some feasible solutions, referring to FIG. 10, a middle wire group coating layer 24 in the differential signal wire group 20 wraps the two cable cores 10 that are arranged side by side together; the middle wire group coating layer 24 is provided with a positioning notch 23; a ground wire 21 cooperates with the positioning notch 23; and the wire group shielding layer 22 wraps the cable cores 10 and the ground wire 21 together.

In practical applications, there may be two ground wires 21. Positioning notches 23 are provided at two ends of the middle wire group coating layer 24; and the ground wires 21 are respectively located on two sides of the two cable cores 10 that are arranged side by side and cooperate with the corresponding positioning notches 23. Or, there may be one ground wire 21. At this time, the positioning notches 23 are provided at positions, corresponding to adjacent positions of the two cable cores 10, on an outer side of the middle wire group coating layer 24.

In practical applications, the positioning notches 23 are not necessary. The ground wires can be directly positioned by using the elasticity of the outer cable core coating layer 13 or the middle wire group coating layer 24 and the compression deformation between the ground wires 21.

In this embodiment, the positioning notches and the wire group shielding layer are used to position and fix the ground wires, which can effectively avoid displacement of the cable cores and the ground wires when a plurality of differential signal wire groups are twisted and when a cable is pulled and stretched, and can maintain the stability of the comprehensive dielectric constant ε.

### Embodiment III

Based on the above Embodiment I, Embodiment III provides a communication cable.

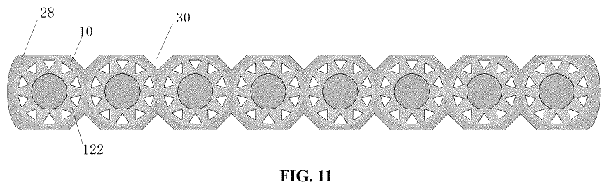

Referring to FIG. 11 to FIG. 14, in some feasible solutions, the communication cable includes at least one row of connected cable. The connected cable includes at least two cable cores 10 that are arranged side by side. Adjacent supporting structures 122 of adjacent cable cores 10 are aligned with each other.

The structure of each cable core 10 can be found in Embodiment I, and will not be elaborated in this embodiment.

In this embodiment, the adjacent supporting structures of the two adjacent cores are aligned with each other to achieve mutual supporting. When the cable is applied with force, the structures of the insulation dielectric layers of the cable cores can be kept stable, thereby maintaining the dielectric constants of the insulation dielectric layers stable.

In some feasible solutions, continuing to refer to FIG. 11, the connected cable is wrapped by an outer cable coating layer 28; and the outer cable coating layer 28 is provided with an anti-break notch 30 at adjacent positions of every two adjacent cable cores 10.

The outer cable coating layer 28 is provided with the anti-break notch (30) at the adjacent positions of every two adjacent cable cores (10). When the communication cable is applied with lateral bending force, the cable can bend at the anti-break notch 30, which not only avoids cable breakage, but also avoids the force on the cable cores 10, thereby ensuring the structural stability of the insulation dielectric layers of the cable cores.

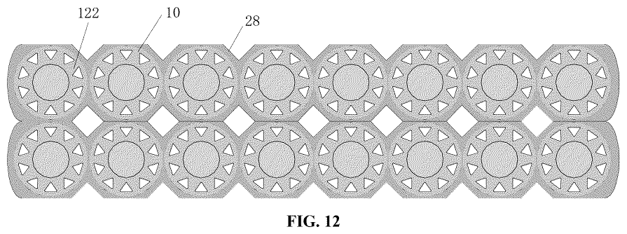

In some feasible solutions, referring to FIG. 12, the communication cable may include at least two rows of connected cables; the outer cable coating layers (28) of the two adjacent rows of connected cables are connected; the cable cores 10 of two adjacent rows of connected cables are aligned pairwise, and the anti-break notches (30) are aligned pairwise too.

The cable cores 10 of the two adjacent rows of connected cables are aligned, so that the supporting structures 122 of the various cable cores 10 correspond one another in up, down, left, and right directions. This allows the cable cores 10 to support each other under force, thereby improving the structural stability of the insulation dielectric layers 12 of the cable cores and reducing the change in the dielectric constant after the cable cores 10 are pressed. Meanwhile, the anti-break notches 30 between the two rows of connected cables are aligned to form the complete holes, so that the cable is elastic, has compression resistance, and is easy to rebound.

### Embodiment IV

Based on the foregoing embodiment, Embodiment IV provides another communication cable.

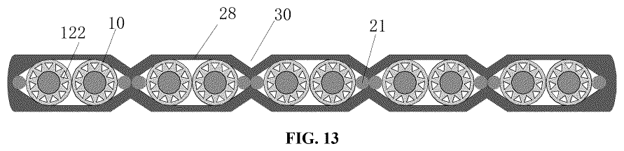

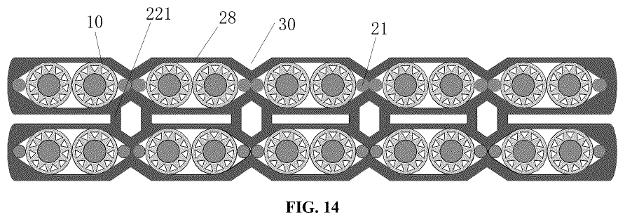

What is different from Embodiment III is that cable cores 10 that are arranged side by side in connected cables of the communication cable are combined pairwise to form a differential signal wire group, and the adjacent supporting structures 122 of the two cable cores 10 are aligned with each other, as shown in FIG. 13 and FIG. 14.

In this embodiment, the structure of the differential signal wire group 20 can be found in FIG. 5 to FIG. 10 of Embodiment II, and will not be elaborated in this embodiment.

In some feasible solutions, continuing to refer to FIG. 13, the connected cables are wrapped by an outer cable coating layer 28; the outer cable coating layer 28 is provided with an anti-break notch 30 at adjacent positions of every two adjacent differential signal wire groups. When the communication cable is applied with lateral bending force, the cable can bend at the notch, which not only avoids cable breakage, but also avoids the force on the cable cores.

In some feasible solutions, referring to FIG. 14, the communication cable includes at least two rows of connected cables; the differential signal wire groups 20 are aligned pairwise, and the anti-break notches 30 are aligned pairwise too; first connecting ribs 221 are arranged at edges of two sides of the anti-break notches 30; and the two rows of connected cables are connected to each other through the first connecting ribs 221.

Due to the first connecting ribs 221, the cable is elastic, has compression resistance, and is easy to rebound. Furthermore, buffering on the outer cable coating layer 28 is enhanced after the force is applied to the cable, which further maintains the structural stability of the insulation dielectric layers of the cable cores.

### Embodiment V

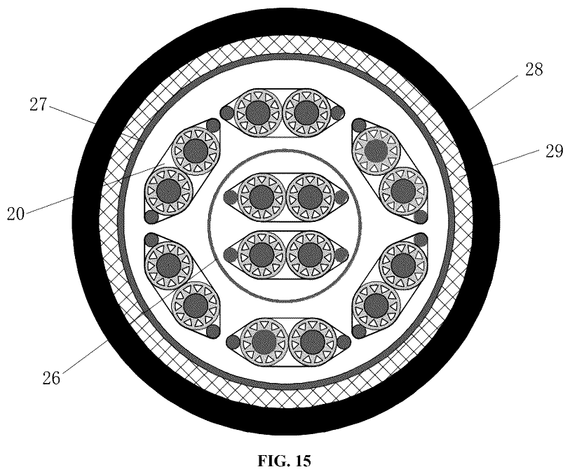

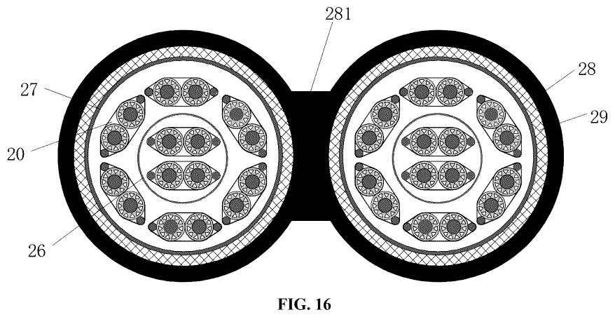

Based on the foregoing embodiments, Embodiment V provides a high-speed differential cable, as shown in FIG. 15 and FIG. 16.

In some feasible solutions, referring to FIG. 15, the communication cable includes one single-core cable. The single-core cable includes a plurality of differential signal wire groups 20 as described in Embodiment II, a first shielding layer 26, a second shielding layer 27, and an outer cable coating layer 28.

The first shielding layer 26 wraps two differential signal wire groups 20 arranged side by side; the second shielding layer 27 wraps the first shielding layer 26; the plurality of differential signal wire groups 20 are arranged around the first shielding layer 26 and located between the first shielding layer 26 and the second shielding layer 27; and the outer cable coating layer 28 wraps the second shielding layer 27.

It should be noted that after the cable is twisted, the blank part in the figure will be pressed, and only a small gap is reserved or the blank part is completely pressed without reserving any gap.

The wire group shielding layer 22, the first shielding layer 26, and the second shielding layer 27 may be all made of an aluminum foil, a copper foil, graphene, and the like. Its width and thickness can be customized according to a need. The wire group shielding layer can be machined by dragging or winding.

The single-core cable is provided with the two shielding layers; the two differential signal wire groups that are arranged side by side are arranged in the first shielding layer 26, and the cable cores 10 of the two differential signal wire groups are aligned, so that the supporting structures 122 of the various cable cores 10 correspond one another in up, down, left, and right directions. This allows the cable cores 10 to support each other under force, thereby improving the structural stability of the insulation dielectric layers 12 of the cable cores and reducing the change in the dielectric constant after the cable cores 10 are pressed.

In some feasible solutions, a braided layer 29 is further arranged between the outer cable coating layer 28 and the second shielding layer 27.

In practical applications, the braided layer can be made of copper, and the size and number of copper wires can be customized according to a need.

In some feasible solutions, the communication cable as shown in FIG. 16 may include two single-core cables; the at least two single-core cables are arranged side by side; the outer cable coating layers 28 of the two single-core cables are connected; and a second connecting rib 281 is formed between the two single-core cables. Due to the second connecting rib 281, the high-speed differential signal cable is elastic, has compression resistance, and is easy to rebound. Furthermore, buffering on the outer cable coating layer is enhanced after the force is applied to the communication cable, which further maintains the structural stability of the insulation dielectric layers 12 of the cable cores.

### Practicability

Due to the cable core and the communication cable in the present disclosure, the cable core has a stable structure and is hardly broken under force, which improves the compressive strength. The stability of the dielectric constant of an insulation medium is improved; the signal transmission efficiency is improved; and it is conductive to improving the machining accuracy of the cable core. The wire groups of the cable cores and the adjacent supporting structures of two adjacent cable cores in the cable are aligned with each other to achieve mutual supporting, which maintains the structural stability of the insulation dielectric layers of the cable cores, so that the dielectric constants of the insulation dielectric layers are maintained stable. Therefore, the authentication and key negotiation method for the wireless sensor network of the present disclosure has practicability.

It should be noted that in the claims, any reference numeral in the parentheses should not be understood as limitations on the claims. The term “include” does not exclude the existence of components or steps that are not listed in the claims. The term “a/an” or “one” in front of a component does not exclude the existence of a plurality of such components. The present disclosure can be implemented by means of hardware including several different components and by means of an appropriately programmed computer. Use of the terms such as first, second, and third is only for the convenience of expression and does not indicate any order. These terms can be understood as a part of a component name.

It will be apparent to those skilled in the art that various changes and transformations can be made to the present disclosure without departing from the spirit and scope of the present disclosure. Thus, if these changes and transformations to the present disclosure fall within the scopes of the claims of the present disclosure and their equivalents, the present disclosure shall be also intended to encompass these changes and transformations.

What is claimed is:

1. A cable core, wherein the cable core comprises a conductor (11) and an insulation dielectric layer (12) wrapping the conductor (11);
a plurality of holes (121) parallel to an axis of the conductor (11) are uniformly provided around the conductor (11) inside the insulation dielectric layer (12); supporting structures (122) are formed between adjacent holes (121);
in any cross section of the cable core, shapes of cross sections of the various holes (121) are the same and are all axisymmetric figures; and an axis of symmetry of the cross section of each hole (121) is intersected with a circle center of the cross section of the conductor (11).

2. The cable core according to claim 1, wherein the cross section of each hole (121) is in a shape of an isosceles triangle;
each isosceles triangle is either an inverted triangle or a forward triangle; or,
the isosceles triangles comprise forward triangles and inverted triangles, and the forward triangles and the inverted triangles are spaced apart from each other;
each inverted triangle means an isosceles triangle with a vertex angle pointing towards the conductor (11); and each forward triangle means an isosceles triangle with a vertex angle pointing towards a direction opposite to a direction pointed by the inverted triangle.

3. The cable core according to claim 2, wherein the isosceles triangles are all inverted triangles; distances from center points of the various inverted triangles to the centers of circle are equal; a width of one end of each columnar supporting structure (122) away from the conductor (11) is less than a width of the other end; or,
the isosceles triangles are all forward triangles; distances from center points of the various forward triangles to the centers of circle are equal;
the isosceles triangles comprise inverted triangles and forward triangles; a number of the forward triangles and a number of the inverted triangles are equal; distances from center points of the various inverted triangles to the centers of circle are equal; distances from center points of the various forward triangles to the centers of circle are equal; and the distances from the center points of the various inverted triangles to the centers of circle are greater than the distances from the center points of the various forward triangles to the centers of circle.

4. The cable core according to claim 3, wherein each isosceles triangle is an equilateral triangle; or,
each isosceles triangle has only two equal sides, and a value of the vertex angle is greater than a value of a base angle.

5. The cable core according to claim 4, wherein the cable core further comprises an outer cable core coating layer (13) wrapping the insulation dielectric layer (12).

6. A communication cable, wherein the communication cable comprises at least one cable core (10) according to claim 1.

7. The communication cable according to claim 6, wherein a plurality of cable cores (10) are arranged in at least one row of connected cable, and adjacent supporting structures (122) of adjacent cable cores (10) are aligned with each other.

8. The communication cable according to claim 7, wherein the connected cable is wrapped by an outer cable coating layer (28); and the outer cable coating layer (28) is provided with an anti-break notch (30) at adjacent positions of every two adjacent cable cores (10).

9. The communication cable according to claim 8, wherein there are at least two rows of connected cables;
the outer cable coating layers (28) of the two adjacent rows of connected cables are connected; and the cable cores (10) are aligned pairwise; and the anti-break notches (30) are aligned pairwise.

10. The communication cable according to claim 6, wherein the communication cable comprises at least one differential signal wire group (20);
the differential signal wire group (20) comprises two cable cores (10); and adjacent supporting structures (122) of the two cable cores (10) are aligned with each other.

11. The communication cable according to claim 10, wherein the differential signal wire group (20) comprises only two cable cores (10); the two cable cores (10) are wrapped together by a middle wire group coating layer (24); a wire group shielding layer (25) and an outer wire group coating layer (26) wrap the middle wire group coating layer (24) in sequence; or,
the differential signal wire group comprises a ground wire (21); the ground wire (21) is arranged at adjacent positions of the two cable cores (10); a wire group shielding layer (22) wraps the two cable cores (10) and the ground wire (21) together; an outer wire group coating layer (25) wraps the wire group shielding layer (22); or,
the differential signal wire group comprises two ground wires (21); the two cable cores (10) are wrapped together by a middle wire group coating layer (24); the two ground wires (21) are located at two ends of an outer side of the middle wire group coating layer (24); a wire group shielding layer (22) wraps the ground wires (21) and the cable cores (10) wrapped by the middle wire group coating layer (24) together; and an outer wire group coating layer

(25) wraps the wire group shielding layer (22).

12. The communication cable according to claim 10, wherein the differential signal wire group (20) further comprises at least one ground wire (21) and a wire group shielding layer (22), the cable cores (10) are provided with positioning notches (23); the ground wire (21) cooperates with the positioning notches (23); the wire group shielding layer (22) wraps the cable cores (10) and the ground wire (21) together; or,
the differential signal wire group (20) further comprises at least one ground wire (21), a wire group shielding layer (22), and a middle wire group coating layer (24); the middle wire group coating layer (24) wraps the two cable cores (10) together; the middle wire group coating layer (24) is provided with a positioning notch (23); the ground wire (21) cooperates with the positioning notch (23); and the wire group shielding layer (22) wraps the cable cores (10) and the ground wire (21) together.

13. The communication cable according to claim 10, wherein the communication cable further comprises an outer cable coating layer (28); a plurality of differential signal wire groups (20) are arranged in at least one row of connected cable; the connected cable is wrapped by the outer cable coating layer (28); and the outer cable coating layer (28) is provided with an anti-break notch (30) at adjacent positions of every two adjacent differential signal wire groups.

14. The communication cable according to claim 13, wherein there are at least two rows of connected cables;
two adjacent rows of differential signal wire groups are aligned pairwise; the anti-break notches (30) are aligned pairwise too; first connecting ribs (221) are arranged at edges of two sides of the anti-break notches (30); and two adjacent rows of connected cables are connected to each other through the first connecting ribs (221).

15. The communication cable according to claim 10, wherein the communication cable comprises at least one single-core cable; each single-core cable comprises a plurality of differential signal wire groups (20), a first shielding layer (26), a second shielding layer (27), and an outer cable coating layer (28);
the first shielding layer (26) wraps two differential signal wire groups (20) arranged side by side; the cable cores (10) of the two differential signal wire groups (20) are aligned with each other;
the second shielding layer (27) wraps the first shielding layer (26); the plurality of differential signal wire groups (20) are arranged around the first shielding layer (26) and located between the first shielding layer (26) and the second shielding layer (27); and
the outer cable coating layer (28) wraps the second shielding layer (27).

16. The communication cable according to claim 15, wherein a braided layer (29) is further arranged between the outer cable coating layer (28) and the second shielding layer (27).

17. The communication cable according to claim 15, wherein the communication cable comprises two single-core cables; the two single-core cables are arranged side by side; the outer cable coating layers (28) of the two single-core cables are connected; and a second connecting rib (281) is formed between the two single-core cables.

18. The communication cable according to claim 6, wherein a cross section of each hole (121) is in a shape of an isosceles triangle;
each isosceles triangle is either an inverted triangle or a forward triangle; or,
the isosceles triangles comprise forward triangles and inverted triangles, and the forward triangles and the inverted triangles are spaced apart from each other;
each inverted triangle means an isosceles triangle with a vertex angle pointing towards the conductor (11); and each forward triangle means an isosceles triangle with a vertex angle pointing towards a direction opposite to a direction pointed by the inverted triangle.

19. The communication cable according to claim 18, wherein the isosceles triangles are all inverted triangles; distances from center points of the various inverted triangles to the centers of circle are equal; a width of one end of each columnar supporting structure (122) away from the conductor (11) is less than a width of the other end; or,
the isosceles triangles are all forward triangles; distances from center points of the various forward triangles to the centers of circle are equal;
the isosceles triangles comprise inverted triangles and forward triangles; a number of the forward triangles and a number of the inverted triangles are equal; distances from center points of the various inverted triangles to the centers of circle are equal; distances from center points of the various forward triangles to the centers of circle are equal; and the distances from the center points of the various inverted triangles to the centers of circle are greater than the distances from the center points of the various forward triangles to the centers of circle.

20. The communication cable according to claim 19, wherein each isosceles triangle is an equilateral triangle; or,
each isosceles triangle has only two equal sides, and a value of the vertex angle is greater than a value of a base angle.
